(19) United States
(12) Patent Application Publication
(10) Pub. No.: US 2026/0099520 A1
(43) Pub. Date: Apr. 9, 2026

(54) CONVERSATION METHODS, ELECTRONIC DEVICES, STORAGE MEDIA, AND PRODUCTS

(71) Applicant: Beijing Zitiao Network Technology Co., Ltd., Haidian District, Beijing (CN)

(72) Inventor: Xiaowei CHEN, Beijing (CN)

(21) Appl. No.: 19/114,053

(22) PCT Filed: Jun. 26, 2024
(86) PCT No.: PCT/CN2024/101616

§ 371 Date: Mar. 21, 2025

(51) Int. Cl. G06F 16/3329; G06F 16/34

(52) U.S. Cl. CPC G06F 16/33295; G06F 16/345

(57) ABSTRACT

The disclosure relates to a conversation method, an electronic device, a storage medium, and a product, which relates to the field of computer technology. The conversation method includes: displaying a conversation between a user and a first agent; generating setting information for a second agent to be created based on the conversation; creating the second agent according to the setting information, wherein the second agent is configured to participate in the conversation between the user and the first agent based on the setting information for the second agent; and displaying the conversation among the user, the first agent and the second agent.

### TECHNICAL FIELD

This disclosure relates to the field of computer technology, particularly to a conversation method, an electronic device, a storage medium, and a product.

### BACKGROUND

With the development of artificial intelligence technology, users may communicate with agents through user devices. The agent is a concept used in computer science to refer to an entity that is capable of autonomously performing tasks in a specific environment. In response to receiving a message sent from a user, an agent can generate a corresponding message and send it to the user. Agents can interact with users as AI customer service representatives, AI assistants, etc.

### SUMMARY

This summary is provided for a concise introduction of the inventive concept of the present application, which will be described in detail in the Detailed Description below. This summary is not intended to identify critical features or essential features of the claimed technical solution, nor is it intended to be used to limit the scope of the claimed technical solution.

According to some embodiments of the present disclosure, there is provided a conversation method, including: displaying a conversation between a user and a first agent; generating setting information for a second agent to be created based on the conversation; creating the second agent according to the setting information, wherein the second agent is configured to participate in the conversation between the user and the first agent based on the setting information for the second agent; and displaying the conversation among the user, the first agent and the second agent.

According to some embodiments of the present disclosure, there is provided an electronic device, including: a memory; and a processor coupled to the memory, wherein the processor is configured to execute instructions stored in the memory to perform the conversation method provided by any embodiment of the present disclosure.

According to some embodiments of the present disclosure, there is provided a computer-readable storage medium stored thereon a computer program that, when executed by a processor, performs the conversation method provided by any embodiment of the present disclosure.

According to some embodiments of the present disclosure, there is provided a computer program, including: instructions that, when executed by a processor, cause the processor to perform the conversation method provided by any embodiment of the present disclosure.

Other features, aspects and advantages of the present disclosure will become apparent from the following detailed description of exemplary embodiments of the present disclosure with reference to the accompanying drawings.

### BRIEF DESCRIPTION OF THE DRAWINGS

Below, preferred embodiments of this disclosure will be described with reference to the drawings. The accompanying drawings described herein are intended to provide a further understanding of the present disclosure, and together with the specific description of the drawings below, are included in and constitute a part of the present specification for illustration of the present disclosure. It should be understood that the drawings described below merely involve some embodiments of the present disclosure, and are not limitations of the present disclosure. In the drawings:

FIG. 1 shows a flowchart of a conversation method according to some embodiments of the present disclosure;

FIG. 2 shows a flowchart of a method for generating setting information according to some embodiments of the present disclosure;

FIG. 3 shows a flowchart of a method for generating setting information according to other embodiments of the present disclosure;

FIG. 4 shows a flowchart of a method for creating a third agent according to some embodiments of the present disclosure;

FIGS. 5A and 5B show schematic diagrams of a conversation interface according to some embodiments of the present disclosure;

FIG. 6 shows a schematic diagram of a creation interface for an agent according to some embodiments of the present disclosure;

FIG. 7 shows a structure diagram of a conversation apparatus according to some embodiments of the present disclosure;

FIG. 8 shows a structure diagram of an electronic device according to some embodiments of the present disclosure;

FIG. 9 shows a structure diagram of a computer system according to some embodiments of the present disclosure.

It should be understood that, for ease of description, the dimensions of the various parts shown in the drawings are not drawn to actual proportions. Throughout the drawings, the same or similar reference signs indicate the same or similar elements. Therefore, once an item is defined in a drawing, there is no need for further discussion in other accompanying drawings.

### DETAILED DESCRIPTION

Below, a clear and complete description will be given for the technical solution of embodiments of the present disclosure with reference to the figures of the embodiments. Obviously, merely some embodiments of the present disclosure, rather than all embodiments thereof, are given herein. The description of the embodiments is merely illustrative, and in no way serves as any limitation on the present disclosure and its application or use. It should be understood that the present disclosure can be implemented in various forms and should not be construed as limited to the embodiments set forth herein.

It should be understood that the various steps described in the methods of the embodiments of the present disclosure may be executed in a different order, and/or executed in parallel. In addition, the methods may include additional steps and/or some of the illustrated steps may be omitted. The scope of this disclosure is not limited in this regard. Unless specifically stated otherwise, relative arrangement and values of components and steps, numerical expressions and values set forth in these embodiments are to be construed as merely illustrative, not limiting the scope of the present disclosure.

The term “comprising” and its variations used in this disclosure refer to an open-ended term that comprises at least the following elements/features, but does not exclude other elements/features, i.e. “comprising but not limited to”. In addition, the term “including” and its variations used in this disclosure refer to an open-ended term that includes at least the following elements/features, but does not exclude other elements/features, i.e., “including but not limited to”. Therefore, the terms “comprising” and “including” are synonymous. The term “based on” means “based at least in part on”.

“An embodiment”, “some embodiments” or “embodiments” used throughout the specification mean that specific features, structures or characteristics described in connection with the embodiments are included in at least one embodiment of the present invention. For example, the term “an embodiment” means “at least one embodiment”; the term “another embodiment” means “at least one additional embodiment”; the term “some embodiments” means “at least some embodiments”. In addition, occurrences of the phrases “in an embodiment,” “in some embodiments,” or “in embodiments” throughout this specification do not necessarily refer to the same embodiment, but may refer to the same embodiment.

It should be noted that the concepts of “first” and “second” mentioned in the present disclosure are only used to distinguish different devices, modules or units, and are not used to limit the order of functions performed by these devices, modules or units, or interdependence therebetween. Unless otherwise specified, terms such as “first” and “second” are not intended to imply that objects described in this way must be in any particular order in time, space, rank, or otherwise.

It should be noted that the modifications of “a” and “a plurality of” mentioned in the present disclosure are illustrative and not restrictive, and those skilled in the art should understand that unless clearly indicated in the context, they should be understood as “one or more”.

The names of messages or information exchanged between multiple devices in the embodiments of the present disclosure are only used for illustrative purposes, and are not used to limit the scope of these messages or information.

The following will provide a detailed explanation of the embodiments disclosed herein with reference to the accompanying drawings, but the present disclosure is not limited to these specific embodiments. The following specific embodiments can be combined with each other, and the same or similar concepts or processes may not be repeated in some embodiments. In addition, in one or more embodiments, specific features, structures or characteristics may be combined in any suitable manner, as will be apparent to those skilled in the art from this disclosure.

First, some concepts involved in this disclosure will be explained.

Agent technology: The agent (intelligent agent) is a concept used in computer science to refer to an entity that is capable of autonomously performing tasks in a specific environment. In multi-agent systems, multiple agents collaborate to solve complex problems. Agents can generate appropriate content based on messages sent from other entities, such as users or agents participating in the conversations, in conversation scenarios and can be implemented in software, hardware, or a combination of software and hardware. Agents can also be referred to as digital humans, robots, and virtual agents of machine learning models. Agents can be implemented based on machine learning models, such as Large Language Models (LLM) or Foundation Models. The machine learning models can be generative models.

Chatbot technology: Chatbots are software that communicate with humans through natural language processing (NLP). They are typically used in fields such as customer service, information retrieval and entertainment. Chatbots can be regarded as a special type of agent.

Multi-Agent Systems (MAS): In MAS, each agent has its own goal and behaviour, and multiple agents achieve a common goal through communication and collaboration.

Context Awareness: Context awareness refers to the ability of an agent to understand the environment and contextual information in which a conversation occurs, in order to provide more relevant and personalized responses.

Generative model: Generative models are used to output target content based on input information. The input information of a generative model includes basic materials for the processing of the generative model during a generation process, such as messages sent by other subjects in a conversation, requirements for the output content, and so on. Generative models include models that generate based on text or images, and their output can be text, images or a combination of text and images. Of course, the input or output of generative models can also be data from other modalities, such as audio, video, or a combination of multiple types of data. Generative models may be single-modality models, such as the models that generate text based on text (referred to as “text to text-generation model”), or models that generate images based on images (referred to as “image to image generation model”); or generative models may also be cross-modality models, the input and output of which belong to different modalities, such as models that generate text based on images (referred to as “text to image generation models”); or the input of generative models may include multiple modalities, and the output of the generative models may also include multiple modalities.

In related technologies, users can have one-to-one conversations with agents, i.e. in a conversation interface, a user can have a conversation with one agent, such as chatting with the agent, asking the agent for help, sending commands to the agent, etc. Some agents are provided with setting (or setup) information, knowledge bases, etc. so that they can provide accurate feedback in response to specific conversation content. Accordingly, if a conversation involves some aspects that are less relevant to an agent, the agent may not be able to respond efficiently and accurately to users. In this case, users may search for other agents, or they may abandon dialogue with agents and turn to other methods such as search engines or asking others for information. Therefore, in related arts, if an agent interacting with a user has difficulty in responding accurately to the user, this can lead to a decrease in the efficiency of information acquisition for the user.

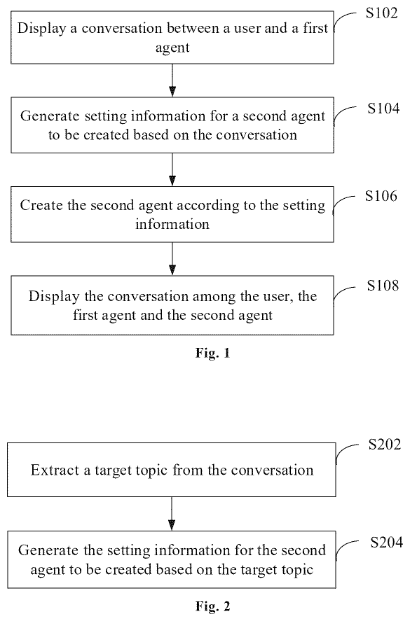

In order to at least partially solve the above technical problems, embodiments of the present disclosure provide a conversation method, an electronic device, a storage medium, and a product. In an embodiment of the present disclosure, during a conversation between a user and a first agent, a second agent is created and added to the conversation, thereby forming a multi-subject conversation or “group chat” among the user and the first and second agents, so that the second agent can compensate for the missing information of the first agent and improve the efficiency of user information acquisition. An embodiment of a conversation method according to the present disclosure will be described below with reference to FIG. 1.

FIG. 1 shows a flowchart of a conversation method according to some embodiments of the present disclosure. As shown in FIG. 1, the conversation method of this embodiment includes steps S102 to S108.

In step 102, a conversation between a user and a first agent is displayed.

The conversation between the user and the first agent includes one or more messages sent by at least one of the user or the first agent, each message including text, voice, image, video, or link, etc. The first agent may be created by an application platform and provided to users for use, or created by the user in step 102, or created and authorized by other users.

Participants in the conversation between the user and the first agent may include only the user and the first agent, or may include other users or other agents. This disclosure does not limit the number of participants in the conversation in step 102.

The user can enter a message to be sent to the first agent using his or her device, such as a keyboard, microphone, touch screen, etc. The message sent by the first agent to the user can be displayed visually on a screen of the user device, and if necessary, a sound corresponding to the message can also be played by a device such as a microphone.

In step 104, setting information for a second agent to be created is generated based on the conversation.

Step 104 can be triggered by the user or automatically triggered based on the content of the conversation. In some embodiments, in the case of automatic triggering, a prompt may be sent by the application system or by the first agent via a conversation message to confirm with the user whether to create the agent. Before creating a new agent for each time, the user can be prompt and the creation process can be carried out upon confirmation. Alternatively, if the user has authorized automatic agent creation in the application, it can be not necessary to confirm with the user each time an agent is created.

The setting information of the second agent is obtained by processing the conversation. In a case where the conversation includes text or speech (which can be converted to text), a generative model that takes a text as input can be used to obtain the setting information; in a case where the conversation includes sound, a generative model that can take sound as input can be used; in a case where the conversation text includes an image or a video, a generative model that can take the image as input can be used. Of course, generative models with multi-modality inputs can also be used.

In some embodiments, a classification model or topic analysis model can also be used to determine a category or a topic of the conversation, and based on a predetermined correspondence between a category or a topic and setting information, information of a second agent corresponding to the conversation is obtained.

In step 106, the second agent is created according to the setting information, wherein the second agent is configured to participate in the conversation between the user and the first agent based on the setting information for the second agent.

Creating a second agent may refer to generating an interface for the second agent. Therefore, in response to the second agent being triggered, for example, in response to the second agent engaging in the conversation, the interface can be called to obtain a conversation message output from the second agent.

In the case where the second agent relies on a machine learning model, the second agent can be considered as a client or agent of the model, which has specific settings, including the generated setting information. This settings are, for example, system prompts. Therefore, the machine learning model can output a conversation message generated by the second agent based on conversation messages generated by other objects in a conversation scenario where the second agent is located, in combination with the setting information.

Alternatively, the setting information can be stored in data corresponding to the second agent. In response to running the control logic of the second agent, the setting information is read to obtain an operation result based on the setting information.

Thus, the information output by the created second agent during the conversation can be associated with the content of the conversation between the user and the first agent, improving the relevance of the second agent to the current conversation scenario.

In some embodiments, the second agent is created based on the setting information and a history of the conversation. Therefore, the messages sent by the created second agent can match the history of the conversation, and there is no need for the user or the first agent to repeatedly input conversation content that has been sent before creating the second agent during the conversation. Therefore, the second agent can efficiently provide information that matches the scenario of the conversation. Of course, as a choice that can be made by those skilled in the art according to practical needs, it is also possible to create a second agent without using the history of the conversation. By maintaining and updating the conversation context between the user and the agent, the new added agent can understand the background of the current conversation and generate coherent and relevant responses based on the context.

In step S108, the conversation among the user, the first agent and the second agent is displayed.

After creating the second agent, it can be pulled into the conversation between the user and the first agent, thereby creating a group chat among the user, the first agent, and the second agent. After the user or the first agent sends a message in the conversation, the second agent can determine whether it needs to speak (i.e., send a message) based on the received message. If necessary, the second agent further processes the received message based on its setting information to output a conversation content of the second agent, i.e., to send a message from the second agent.

According to the above embodiment, during the conversation between the user and the first agent, a second agent can be automatically created based on the conversation content to form a group chat among the user, the first agent, and the second agent. Therefore, the second agent can automatically participate in the conversation between the user and the first agent, and provide more information to the user, improving the efficiency of user information acquisition.

Additionally, by adding an agent to the conversation, the user can remain in the original conversation interface during the above process. In this way, the user does not need to perform complex operations and can obtain more information from the new agent, which improves the efficiency of information acquisition.

In the above embodiment, steps 102 and 108 may be performed on a user device, for example, in an application on the user device, which may be an application having the function of conversing with agents. Some or all of steps 104 and 106 may be performed on the user device (such as in the application on the user device), or some or all of steps 104 and 106 may also be performed on a device other than the user device, such as a server. Those skilled in the art may determine the execution subjects of these steps based on the performance of the user device or computing requirements.

The setting information of the agent can be determined based on the content of the conversation, such as a topic of the conversation. Because the conversation between the user and the agent can involve one or more topics, the agent's setting information can be determined based on a target topic(s) from one or more topics. An embodiment of generating the setting information based on a target topic will be described below with reference to FIG. 2.

FIG. 2 shows a flowchart of a method for generating the setting information according to some embodiments of the present disclosure. As shown in FIG. 2, the generation method of this embodiment includes steps S202 to S204.

In step S202, a target topic is extracted from the conversation.

The target topic can be a recently discussed topic, a topic the user is concern, or a predefined type of topic. For example, a topic analysis model can be used to process the conversation to obtain one or more topics and the target topic is extracted from these topics. As another example, the conversation and requirements for the target topic can be input into a generative model to obtain a target topic output from the generative model.

The target topic can be determined based on at least one of the generation order, or the amount of information of the one or more topics extracted from the conversation. For example, based on a generation order of the one or more topics, a specified number of recently generated topics can be used as target topics, so that the target topics are the topics involved in the user's most recent conversation messages with the first agent. As another example, a specified number of topics with the largest amount of information can be used as the target topics, so that the target topics are the topics that the user are more concerned about in conversations. The amount of information can be represented by word count, frequency of occurrence, etc. Alternatively, a semantic analysis model can be used to process the conversation in each topic to obtain the amount of information. As another example, by combining the order of topic generation and the amount of information, for example, a specified number of recently generated topics with an amount of information greater than a threshold can be used as the target topics. This allows the target topics to match the topics the user concerns.

The target topic can also be a topic predicted based on the conversation. That is, the target topic can be a topic that is not currently involved in the conversation, but may come up in the future. For example, based on one or more topics in the historical conversations, the next topic involved in the conversation can be predicted. Sequence-based machine learning models such as Recurrent Neural Networks (RNNs), Long Short Term Memory (LSTM) networks can be used for prediction. Historical conversations can also be input directly into a generative model to instruct the generation of upcoming conversation content. Thus, it is possible to predict in advance the topics that the user concerns, and timely send effective information to the user from the second agent.

In addition, in a case where the conversation between the user and the first agent is based on a specified story background, a target topic to be generated can be determined based on the story background and the content of the current conversation. For example, the user and the first agent can engage in role-playing and discussion based on a specific story background (such as a script or storyline). In this case, the target topic can be the next plot in the story background.

In step S204, the setting information for the second agent to be created is generated based on the target topic.

The setting information of the second agent is associated with the target topic, which can be derived information, related information, etc. of the target topic. The following examples illustrate several methods for generating the setting information based on a target topic. In some embodiments, the target topic can be input into a generative model to obtain generated setting information that matches the target topic; or the setting information corresponding to the target topic can be determined based on a correspondence between a predetermined topic and the setting information.

In some embodiments, generating setting information for the second agent includes: generating a summary of the conversation; and generating the setting information for the second agent to be created based on the summary of the conversation and difference information between the target topic and setting information for the first agent

The summary of the conversation is used to summarize the main content of the conversation. The summary of the conversation may be more comprehensive than the target topic. Thus, when generating the setting information based on the target topic, key information in the conversation context will not be lost, thereby making the generated second agent more compatible with the current conversation scenario.

In some embodiments, the conversation can be input into a generative model and a processing instruction for generating a summary can be input into the generative model to generate the summary of the conversation. The input conversation can be all or some conversation content between the user and the first agent. For example, the input conversation can be the most recent content of the conversation within a specified time period, or the most recent conversation content with a specified amount of information (such as word count, etc.).

The difference between the target topic and the first agent's setting information reflects such information that the first agent cannot cover in the current conversation, for example, a field not addressed by the first agent. Therefore, the created second agent can compensate for the missing information of the first agent and provide the user with more comprehensive information.

For example, the first agent is an “English Translation Assistant” that answers translation-related questions raised by the user. If the user is talking more about traveling to the UK, a “UK Travel Assistant” can be created as a second agent and join the group chat to respond to the user in a timely manner on the current conversation interface, thereby improving the efficiency of the user in gathering information.

In some embodiments, the setting information includes at least one of an attribute of the second agent or a relationship between the second agent and the first agent. Generating the setting information for the second agent to be created includes: generating a summary of the conversation; and generating, based on the summary of the conversation and the target topic, at least one of the attribute of the second agent or the relationship between the second agent and the first agent.

The second agent's attributes describe its basic information, such as gender, occupation, hobbies, birthday, or major, making the characteristics of the generated second agent clearer. The relationship between the second agent and the first agent reflects their correlation, such as family, friends, teacher-student, etc., making the process of the second agent joining the conversation smoother and more natural.

Both the attributes and the relationship can be generated with reference to the summary of the conversation and the target topic. Thus, the generated second agent can adapt to the current context and provide more information that matches the target topic.

In some embodiments, the setting information comprises background information of the second agent and at least one of an attribute of the second agent or a relationship between the second agent and the first agent. Generating the setting information for the second agent to be created comprises: determining at least one of the attribute of the second agent or the relationship between the second agent and the first agent; and generating the background information of the second agent based on a summary of the conversation, and at least one of the attribute of the second agent or the relationship between the second agent and the first agent.

In this embodiment, the attributes of the second agent and the relationship between the second agent and the first agent may be automatically generated, for example, in the manner described in the previous embodiment. Alternatively, it can be input by the user or edited by the user based on an automatically generated result. After determining the attributes of the second agent or the relationship between the second agent and the first agent, background information can be further generated based on the summary of the conversation to provide more comprehensive setting information for the second agent. This background information may or may not be displayed to the user, and is taken as a basis for generating subsequent conversation. The background information can describe what has happened to the virtual second agent in the past (e.g. has he traveled to different countries around the world or has he worked and lived in one city). Thus, the conversation messages generated by the second agent can better match its background information.

In some embodiments, the setting information includes a knowledge base of the second agent. Generating the setting information for the second agent to be created includes: generating the knowledge base of the second agent based on a knowledge base of the first agent and a knowledge base related to the target topic.

The knowledge base is used to provide a basis for generating conversation messages for the second agent. For example, when generating a conversation, the second agent can search the knowledge base for data related to or corresponding to the input and process that data to generate the content of the second agent's conversation message. The knowledge base can be a local database, an online database, a search engine, and so on. Providing the agent with as many knowledge bases as possible can improve the agent's information coverage. Accordingly, it also increases the computational cost and time of the agent during processing, which can affect the performance of the agent. By configuring an appropriate knowledge base for the agent, it is possible to improve its processing efficiency while providing the user with effective and accurate information.

The knowledge base of the second agent needs to contain the knowledge related to the target topic in order to provide effective information to the user. In addition, the knowledge base of the second agent can also be determined based on a knowledge base of the first agent. For example, it is necessary to cover the knowledge base of the first agent so that the second agent has more extensive information sources than the first agent. Of course, it is also possible to exclude the first agent's knowledge base from the second agent's knowledge base based on the first agent's knowledge base, so that the first agent and the second agent can provide knowledge in different domains to improve processing efficiency.

In the process of determining a character (role) of the second agent, it can be generated from the characters associated with the first agent. In some embodiments, one or more candidate associated characters of the first agent are determined based on setting information of the first agent; and based on a degree of correlation between each of the candidate associated characters and the conversation, agent(s) to be created are determined from the candidate associated characters, wherein the second agent is any of the agent(s) to be created. Thus, the created second agent can have a correlation with the first agent, making the process of the second agent joining the conversation smoother.

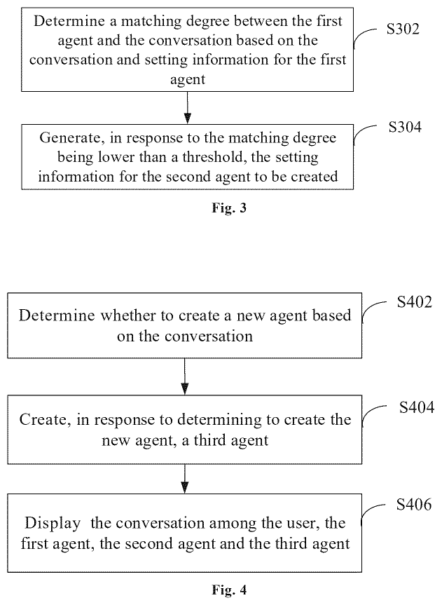

During the conversation between the user and the first agent, it is possible to automatically decide whether to generate an agent based on the progress of the conversation. FIG. 3 shows a flowchart of a method for generating the setting information according to other embodiments of the present disclosure. As shown in FIG. 3, the generation method of this embodiment includes steps S302 to S304.

In step 302, a matching degree between the first agent and the conversation is determined based on the conversation and setting information for the first agent.

The matching degree is used to indicate whether the conversation between the user and the first agent deviates from the information that the first agent can provide. For example, according to the setting information of the first agent, its expertise is English. If the conversation between the user and the first agent involves mathematical problems, the matching degree between the first agent and the current conversation is low. The matching degree can be specific numeric values, multiple levels, or Match/Non-match.

In some embodiments, a similarity between the conversation and the setting information can be calculated and used as the matching degree. When calculating the matching degree, it can be determined based on feature vectors of the conversation and the setting information. The features of the conversation and the setting information can be obtained through a feature extraction model.

In step S304, in response to the matching degree being lower than a threshold, the setting information for the second agent to be created is generated.

If the matching degree is below the threshold, it indicates that the first agent is unable to continue providing effective information to the user. In this case, a process of generating the setting information for the second agent can be triggered, which in turn triggers a creation process of the second agent. That is, in response to the matching degree being lower than the threshold, the creation of the second agent is triggered and the second agent is control to participate in the conversation between the user and the first agent.

The above embodiment can automatically create and introduce a second agent into the conversation between the user and the first agent based on the first agent's ability to support the content of the conversation. Therefore, when the first agent is unable to further provide effective information to the user, information can be timely provided by the second agent, thereby improving the efficiency of user information acquisition.

In the case of automatically triggering the creation of the second agent, the process of determining whether to create the second agent (or determining whether to generate setting information for the second agent) can be triggered at a specified interval, or this determination process can be triggered after each new message is produced in the conversation. For example, based on the conversation, it can be determined whether to create a new agent. In response to the determination to create a new agent, a second agent can be created to display the conversation among the user, the first agent, and the second agent.

After the second agent participates in the conversation, it is also possible to determine whether a further new agent should be created based on the logic described above. An embodiment of the method for determining whether to create a new agent will be described below with reference to FIG. 4.

FIG. 4 shows a flowchart of a method for creating a third agent according to some embodiments of the present disclosure. As shown in FIG. 4, the creation method of this embodiment includes steps S402 to S406.

In step S402, whether to create a new agent based on the conversation is determined. For example, reference may be made to the foregoing embodiments to determine whether to create the new agent based on the matching degree. In addition, other methods can also be used to trigger the creation of the new agent. For example, if the user sends a message expressing a desire to invite a new agent to join the conversation, it is determined that a new agent will be created. The specific meaning of the message sent by the user can be determined by a semantic analysis model.

In step S404, in response to determining to create the new agent, a third agent configured to participate in the conversation among the user, the first agent, and the second agent is created based on setting information for the third agent. For the creation method of the third agent, reference can be made to that of the second agent, which will not be repeated here.

In step S406, the conversation among the user, the first agent, the second agent and the third agent is displayed.

In some embodiments, in response to determining not to create a new agent, the next agent to send a conversation message is determined based on the conversation. For example, it is determined whether a message should be sent by the first agent, the second agent, or other agents (if any). For another example, if it is determined that the user should continue speaking at this time, it is not necessary to instruct any agent to send a conversation message.

When determining whether to have an agent speak or create a new agent, the Next Token Prediction ability of a machine learning model can be used, i.e., the model is used to predict whether the next action will be performed by an agent already involved in the conversation or by a new agent, and then to make a decision.

An exemplary description of the interaction between multiple agents will be given below.

The multiple agents are in a same virtual environment and share the virtual environment, which includes global state information. The agents can interact with each other and update information. Each agent takes on a corresponding role and performs tasks based on its settings information. A controller can be used for decision making to control the interaction between different agents. The controller can be a model (such as an LLM model) or a predefined rule that is responsible for switching between different agents and task stages, managing the order of agent actions, e.g., controlling which agent is currently designated to send a message. In addition, it is necessary to perform “memory maintenance” on the agents. In the multi-agent framework, memories include not only the interaction history between the user and the agents, but also the internal state of each agent and the interaction history between the agents to ensure the coherence of the conversation. The agent invokes a model to perform a specific action based on an instruction of a controller, such as generating conversation content, invoking tool plug-ins, and so on. After the action is executed, the agent sends its output information to the conversation interface or updates it to a shared public environment for use by other agents.

Through this interaction process, a multi-agent system can perform complex tasks efficiently while maintaining natural and logical interactions between multiple roles. A user can enter a multi-role interaction mode by selecting different roles, achieving a group chat function and realizing a variety of conversational experiences created by multiple agents.

In the above embodiment, a third agent may also be added to the conversation as the conversation progresses. That is, an embodiment of this disclosure supports the creation of multiple agents during a conversation process, as well as a collaborative conversation among the created agents and the user.

A conversation method provided in an embodiment of this disclosure will be described below with reference to the schematic diagrams of some conversation interfaces and related interfaces.

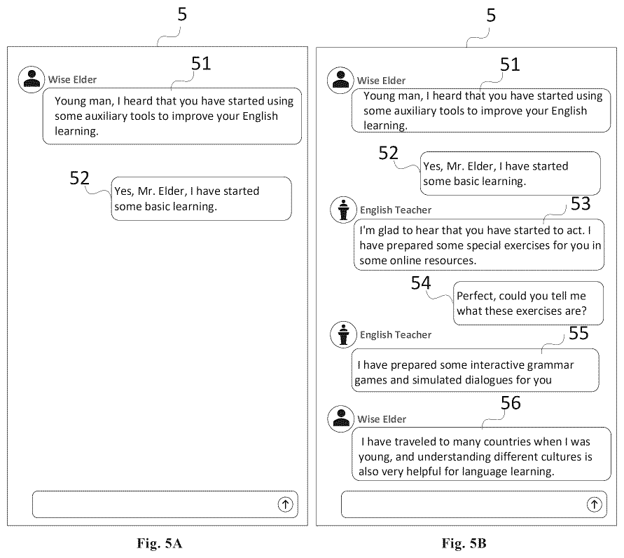

FIGS. 5A and 5B show the schematic diagrams of a conversation interface according to some embodiments of the present disclosure. As shown in FIG. 5A, in a conversation interface 5, a user conducts a conversation with a “Wise Elder” agent. By way of example, messages sent by the agent are displayed with left alignment, while messages sent by the user are displayed with right alignment.

In the conversation, the “Wise Elder” agent sends a message 51, “Young man, I heard that you have started using some auxiliary tools to improve your English learning.” After receiving the message 51, the user sends a message 52, “Yes, Mr. Elder, I have started some basic learning,” indicating that the user already has some foundation in learning English. Upon evaluation, the content of the message 52 sent by the user is excessive for the information that can be covered by the “Wise Elder” agent. Based on the current topic of discussion, an “English Teacher” agent is automatically created and added to the conversation between the user and the “Wise Elder” agent. As shown in FIG. 5B, the “English teacher” agent sends a message 53 based on the last message 52 sent by the user: “I'm glad to hear that you have started to act. I have prepared some special exercises for you in some online resources. ”. After that, the user, “English Teacher,” and “Wise Elder” continue to interact by sending messages such as 54 to 56. Additional agents can be invited to join the group chat as needed.

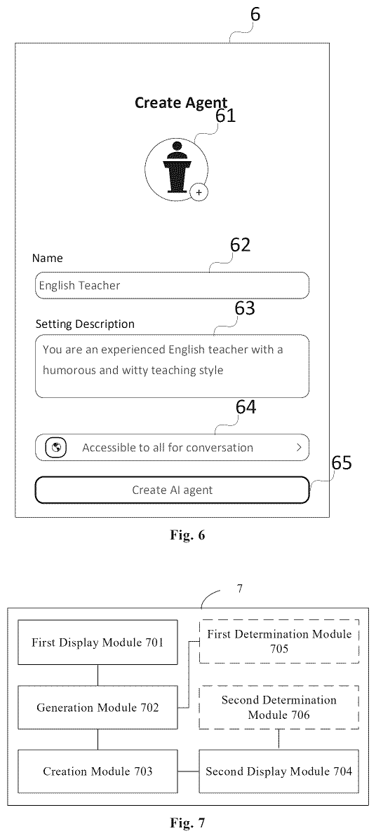

In some embodiments, prior to creating the second agent, the setting information of the second agent may also be displayed through a creation interface for the user to modify or confirm. FIG. 6 shows a schematic diagram of a creation interface for an agent according to some embodiments of the present disclosure. As shown in FIG. 6, in a creation interface 6, the setting information of the created second agent “English Teacher” is displayed, including avatar 61, name 62, description 63, access permission 64, and so on. The user can modify one or more of them as needed. After the user confirms the setting information displayed in the interface 6, the creation process of the second agent can be completed by triggering a Create control 65.

The creation interface 6 contains input fields where some setting information is filled in, and the initial content of such setting information can be automatically generated. The user can also choose from some alternative information as needed. In some embodiments, the setting information for the second agent to be created is displayed, the setting information comprising one or more pieces of alternative information; a selection operation of the user on the alternative information is received; and the second agent is created based on alternative information selected by the user. The one or more pieces of alternative information may be generated according to the methods described in the foregoing embodiments. In the case of generating multiple pieces of alternative information, the model that generates the setting information can be instructed to output multiple results, or multiple different models can be used to output results separately. By presenting one or more pieces of alternative information for the user to select, it is possible to improve the efficiency of user operations while allowing the user to customize the agent. In some embodiments, after selecting a piece of alternative information, the user may further edit the selected information to meet his or her personalized needs.

The creation interface 6 may be displayed in response to determining the need to create a second agent, such as after the conversation interface 5 shown in FIG. 5A. In response to the user triggering the Create control 65, the conversation interface 5 is resumed, as shown in FIG. 5B. The creation interface 6 can be displayed in a full-screen mode on the user's device or as a floating layer on top of the conversation interface 5.

An embodiment of this disclosure may include interactions between a frontend, a backend, control logic (implemented based on an algorithm), and models. The frontend is responsible for providing the user with an interactive interface for interacting with agents, as well as creating and setting roles. The backend is used to process user input, store role information, and integrate it into the conversation system. The backend is also responsible for invoking control logic and models to generate natural and smooth conversation content, and to ensure that the interaction between the agent and the user conforms to predetermined logic and background stories. The algorithm plays a coordinating role in the multi-agent system, for example, dynamically adjusting and optimizing the behavior of the agents based on user input and the progress of the conversation. The algorithm is responsible for assigning roles and tasks to different models, so that each agent can participate in the conversation according to its setting information.

An exemplary description of the interaction process between the user interface, the frontend, and the backend will be given below. The user enters setting information for a user-created agent through the interaction interface, which is then received, formatted, and stored by the front end. The backend receives and stores the formatted setting information of the agent. Then, the backend integrates the stored setting information of the agent into the conversation environment, and displays the setting result of the agent via the frontend to display the information of the user-created agent. Next, the user can select a created agent for a conversation. Of course, the agent can be created by the user, created by other users, or provided by the application. After receiving the user's selection, the frontend integrates the agent into the conversation environment, calls the formatted setting information of the agent involved in the conversation environment, and sends it to the backend. The backend invokes an algorithm to assign tasks to each agent. For example, if it is necessary to instruct an agent to speak, a model is called to generate a message. Based on the agent's setting information, the model performs the appropriate operations to generate the agent's conversation content. The generated conversation content is output to the chat environment, i.e., the conversation interface. For example, if a new agent needs to be created, the new agent is generated and added to the conversation environment. The algorithm coordinates the interaction of multiple agents. Therefore, both the interaction between existing agents and the interaction between existing agents and newly created agents can continue the original content of the conversation.

Some method embodiments of the present disclosure have been introduced above. An apparatus provided in this disclosure for carrying out the methods of the above embodiments will be described below.

FIG. 7 shows a structure diagram of a conversation apparatus according to some embodiments of the present disclosure. As shown in FIG. 7, the conversation apparatus 7 of this embodiment includes: a first display module 701 configured for displaying a conversation between a user and a first agent; a generation module 702 configured for generating setting information for a second agent to be created based on the conversation; a creation module 703 configured for creating the second agent according to the setting information, wherein the second agent is configured to participate in the conversation between the user and the first agent based on the setting information for the second agent; and a second display module 704 configured for displaying the conversation among the user, the first agent and the second agent.

In some embodiments, the generation module 702 is further configured for: extracting a target topic from the conversation; and generating the setting information for the second agent to be created based on the target topic.

In some embodiments, the generation module 702 is further configured for: generating a summary of the conversation; and generating the setting information for the second agent to be created based on the summary of the conversation and difference information between the target topic and setting information for the first agent.

In some embodiments, the setting information comprises at least one of an attribute of the second agent or a relationship between the second agent and the first agent, wherein the generation module 702 is further configured for: generating a summary of the conversation; and generating, based on the summary of the conversation and the target topic, at least one of the attribute of the second agent or the relationship between the second agent and the first agent.

In some embodiments, the setting information comprises at least one of an attribute of the second agent or a relationship between the second agent and the first agent, wherein the generation module 702 is further configured for: determining at least one of the attribute of the second agent or the relationship between the second agent and the first agent; and generating the background information of the second agent based on a summary of the conversation, and at least one of the attribute of the second agent or the relationship between the second agent and the first agent.

In some embodiments, the setting information comprises a knowledge base of the second agent, wherein the generation module 702 is further configured for: generating the knowledge base of the second agent based on a knowledge base of the first agent and a knowledge base related to the target topic.

In some embodiments, the target topic is determined based on at least one of a generation order or an amount of information of one or more topics extracted from the conversation; or the target topic is a topic predicted based on the conversation.

In some embodiments, the generation module 702 is further configured for: determining a matching degree between the first agent and the conversation based on the conversation and setting information for the first agent; and generating, in response to the matching degree being lower than a threshold, the setting information for the second agent to be created.

In some embodiments, the creation module 703 is further configured for: displaying the setting information for the second agent to be created, the setting information comprising one or more pieces of alternative information; receiving a selection operation of the user on the alternative information; and creating the second agent based on alternative information selected by the user.

In some embodiments, the conversation apparatus 70 further comprises: a first determination module 705 configured for determining one or more candidate associated characters of the first agent based on setting information of the first agent; and determining, based on a degree of correlation between each of the candidate associated characters and the conversation, agent(s) to be created from the candidate associated characters, wherein the second agent is any of the agent(s) to be created.

In some embodiments, the creation module 703 is further configured for: determining whether to create a new agent based on the conversation; creating, in response to determining to create the new agent, a third agent configured to participate in the conversation among the user, the first agent, and the second agent based on setting information for the third agent; and the second displaying module 704 is further configured for displaying the conversation among the user, the first agent, the second agent and the third agent.

In some embodiments, the conversation apparatus 705 further comprises: a second determination module 706 configured for: determining, in response to determining not to create the new agent, a next agent to send a conversation content based on the conversation.

In some embodiments, the creation module 703 is further configured for: creating the second agent based on the setting information and a history of the conversation.

It should be noted that the above units are only logical modules divided according to their specific functions and are not intended to limit the specific ways in which they are implemented. For example, they may be implemented in software, hardware or a combination of software and hardware. In practical implementation, the above units may be implemented as independent physical entities, or they can also be implemented by a single entity (such as a processor (CPU or DSP), integrated circuit, etc.). In addition, the above units are indicated by dashed lines in the accompanying drawings, indicating that these units may not actually exist and that the operations/functions they perform may be performed by a processing circuit per se.

In addition, although not shown, the device may also include a memory that can store various information generated by the device or various units in the device during operation, programs and data used for operation, data to be sent by a communication unit, and so on. The memory may be volatile memory and/or non-volatile memory. For example, the memory may include, but is not limited to, random access memory (RAM), dynamic random access memory (DRAM), static random access memory (SRAM), read-only memory (ROM), and flash memory. Of course, the memory may also be located outside of the device. Optionally, although not shown, the device may also include a communication unit that may be used to communicate with other apparatus. In an example, the communication unit may be implemented in any suitable manner known in the art, including communication components such as an antenna array and/or radio frequency links, various types of interfaces, communication units, and so on, which will not be described in detail herein. In addition, the device may also include other components not shown, such as a RF link, a baseband processing unit, a network interface, a processor, a controller, etc., which will not be described in detail herein.

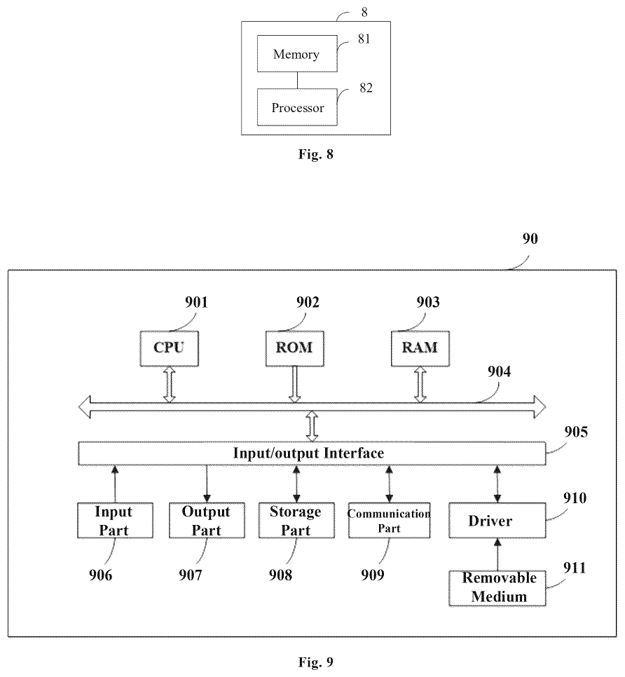

Some embodiments of the present disclosure further provide an electronic device. FIG. 8 shows a structure diagram of an electronic device according to some embodiments of the present disclosure. For example, in some embodiments, the electronic device 8 may be any type of electronic device, such as, but not limited to, a mobile terminal such as a mobile phone, a laptop, a digital broadcast receiver, a PDA (personal digital assistant), a PAD (tablet computer), a PMP (portable multimedia player), a vehicle terminal (such as vehicle navigation terminal), or a fixed terminal such as a digital TV, a desktop computer, etc. For example, the electronic device 8 may include a display panel for displaying data and/or execution results utilized in the scheme of the present disclosure. For example, the display panel can have various shapes. For example, it can be a rectangular panel, an elliptical panel, or a polygonal panel. Furthermore, the display can be not only flat, but curved or even spherical.

As shown in FIG. 8, the electronic device 8 of this embodiment comprises: a memory 81 and a processor 82 coupled to the memory 81. It should be noted that the components of the electronic device 8 shown in FIG. 8 are illustrative and not limiting. Depending on the actual application requirements, the electronic device 8 may include other components. The processor 82 can control other components in the electronic device 8 to perform desired functions.

In some embodiments, the memory 81 is used to store one or more computer-readable instructions. The processor 82 is used to execute these computer-readable instructions that, when executed by the processor 82, perform the method according to any of the above embodiments. The specific implementation of each step of the method and related explanations can be found in the above embodiments, and will not be repeated here.

For example, the processor 82 and the memory 81 can directly or indirectly communicate with each other. For example, the processor 82 and the memory 81 can communicate over a network. The network can be a wireless network, a wired network, and/or any combination of wireless and wired networks. The processor 82 and the memory 81 may also communicate with each other over a system bus, and this disclosure is not limited thereto.

For example, the processor 82 may be embodied as various suitable processors, processing devices, etc., such as a central processing unit (CPU), a graphics processing unit (GPU), a network processor (NP), etc.; It can also be a digital signal processor (DSP), an application specific integrated circuit (ASIC), a field programmable gate array (FPGA), or other programmable logic devices, discrete gates or transistor logic devices, or discrete hardware components. The central processing unit (CPU) may be based on the X86 or ARM architecture. For example, the memory 81 may include any combination of various forms of computer-readable storage media, such as volatile memory and/or non-volatile memory. The memory 81 may include a system memory, which stores an operating system, application programs, a boot loader, a database, and other programs. Various applications and data can also be stored in the storage media.

In addition, according to some embodiments of the present disclosure, various operations/processes according to the present disclosure may be implemented by software and/or firmware, and programs constituting the software may be installed, from storage media or networks, on a computer system having dedicated hardware structures, such as the computer system 90 shown in FIG. 9. The computer system with various programs installed can perform various functions, including those functions mentioned above. FIG. 9 shows a structure diagram of a computer system according to some embodiments of the present disclosure.

In FIG. 9, the central processing unit (CPU) 901 performs various processes based on programs stored in the read-only memory (ROM) 902 or programs loaded from the storage device 708 to the random access memory (RAM) 903. Data required for CPU 901 to perform various processes is also stored in RAM 903 as needed. The central processing unit is only an example and can also be other types of processors, such as the various processors mentioned above. The ROM 902, RAM 903, and storage section 908 may be various forms of computer readable storage media, as described below. It should be noted that although ROM 902, RAM 903, and storage device 908 are shown separately in FIG. 9, one or more of them may be combined or located in the same or different memory or storage modules.

The CPU 901, the ROM 902, and the RAM 903 are connected to each other via a bus 904. An input/output (I/O) interface 905 is also connected to the bus 904.

The following components are connected to the input/output interface 905: an input section 906, such as a touch screen, a touch pad, a keyboard, a mouse, an image sensor, a microphone, an accelerometer, a gyroscope, etc.; an output section 707, including a display such as a cathode ray tube (CRT), liquid crystal display (LCD), a speaker, a vibrator, etc.; a storage section 908, including a hard disk drive, a magnetic tape drive, etc.; and a communication section 909 including a network interface card, such as a LAN card, a modem, etc. The communication section 909 allows communication to be performed over a network, such as the Internet. It is easy to understand that although the various devices or modules in the computer system 90 are shown in FIG. 9 communicating over the bus 904, they may also communicate over networks or other means, where the networks may include wireless networks, wired networks, and/or any combination of wireless and wired networks.

A drive 910 is also connected to input/output interface 905 as needed. A removable medium 911, such as a magnetic disk, an optical disk, a magneto-optical disk, a semiconductor memory, etc., is mounted on the drive 910 as needed so that computer programs read from the medium can be installed in the storage section 908 as needed.

In the case of implementing the above series of processes by software, the programs that make up the software may be installed from a network, such as the Internet, or from a storage medium, such as the removable medium 911.

According to an embodiment of the present disclosure, the processes described above with reference to the flowchart can be implemented as a computer software program. For example, some embodiments of the present disclosure include a computer program product comprising a computer program carried on a computer-readable medium, the computer program containing program code for performing the method illustrated in the flowcharts. In such an embodiment, the computer program may be downloaded and installed from the network via the communication device 909, or installed from the storage device 908 or from the ROM 902. When the computer program is executed by a CPU 901, the above functions defined in the method provided by the embodiment of the present disclosure are performed.

It should be noted that, in the context of the present disclosure, a computer-readable medium may be a tangible medium, which may contain or store a program for use by or in connection with an instruction execution system, apparatus, or device. The computer readable medium may be a computer readable signal medium or a computer readable storage medium, or any combination of thereof. The computer readable storage medium may be, but is not limited to: an electronic, magnetic, optical, electromagnetic, infrared, or semiconductor system, apparatus, or device, or any combination of the above. More specific examples of the computer readable storage medium may include, but are not limited to: electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing. In the present disclosure, a computer readable storage medium can be any tangible medium that can contain or store a program, which can be used by or in connection with an instruction execution system, apparatus or device. In the present disclosure, a computer readable signal medium may include a data signal that is propagated in the baseband or as part of a carrier, carrying computer readable program code. Such propagated data signals can take a variety of forms including, but not limited to, electromagnetic signals, optical signals, or any suitable combination of the foregoing. The computer readable signal medium can also be any computer readable medium other than a computer readable storage medium, which can transmit, propagate, or transport a program for use by or in connection with the instruction execution system, apparatus, or device. Program code embodied on a computer readable medium can be transmitted by any suitable medium, including but not limited to wire, fiber optic cable, RF (radio frequency), etc., or any suitable combination of the foregoing.

The above computer readable medium may be included in the electronic device described above; or it may exist alone without being assembled into the electronic device.

In some embodiments, there is further provided a computer program, comprising: instructions that, when executed by a processor, cause the processor to perform the method of any one of the above embodiments. For example, the instructions can be embodied as computer program code.

In embodiments of the present disclosure, computer program code for executing operations of the present disclosure may be complied by any combination of one or more program design languages, the program design languages including, but not limited to, object-oriented program design languages, such as Java, Smalltalk, C++, etc., as well as conventional procedural program design languages, such as “C” program design language or similar program design language. A program code may be completely or partly executed on a user computer, or executed as an independent software package, partly executed on the user computer and partly executed on a remote computer, or completely executed on a remote computer or server. In the latter circumstance, the remote computer may be connected to the user computer through various kinds of networks, including local area networks (LAN) or wide area networks (WAN), or connected to external computers (for example using an Internet service provider via the Internet).

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. It should also be noted that, in some alternative implementations, the functions noted in the block may occur out of the order noted in the drawings. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The modules, components or units involved in the embodiments described in the present disclosure can be implemented by software or hardware. Wherein, the names of the modules, components or units do not constitute a limitation on the modules, components or units themselves under certain circumstances.

The functions described above may be performed at least in part by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD), etc.

The above description only shows some embodiments of the present disclosure and illustrates technical principles applied in the present disclosure. Those skilled in the art should understand that the scope of disclosure involved in this disclosure is not limited to the technical solutions formed by the specific combination of the above technical features, and should also cover other technical solutions formed by any combination of the above technical features or their equivalent features without departing from the disclosed concept, for example, technical solutions formed by replacing the above features with technical features having similar functions to (but not limited to) those disclosed in the present disclosure.

Many specific details are elaborated in the description of the present disclosure. However, it is understood that embodiments of the present invention can be implemented without these specific details. In other cases, well-known methods, structures, and techniques are not described in detail so as not to obscure the understanding of the description.

In addition, although the operations are depicted in a specific order, this should not be understood as requiring these operations to be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable subcombination.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified without departing from the scope and spirit of the present disclosure. The scope of the disclosure is defined by the following claims.

1. A conversation method, comprising:
displaying a conversation between a user and a first agent; generating setting information for a second agent to be created based on the conversation;
creating the second agent according to the setting information, wherein the second agent is configured to participate in the conversation between the user and the first agent based on the setting information for the second agent; and
displaying the conversation among the user, the first agent and the second agent.

2. The conversation method according to claim 1, wherein the generating the setting information for the second agent to be created based on the conversation comprises:
extracting a target topic from the conversation; and
generating the setting information for the second agent to be created based on the target topic.

3. The conversation method according to claim 2, wherein the generating the setting information for the second agent to be created based on the target topic comprises:
generating a summary of the conversation; and
generating the setting information for the second agent to be created based on the summary of the conversation and difference information between the target topic and setting information for the first agent.

4. The conversation method according to claim 2, wherein the setting information comprises at least one of an attribute of the second agent or a relationship between the second agent and the first agent, and the generating the setting information for the second agent to be created based on the target topic comprises:
generating a summary of the conversation; and
generating, based on the summary of the conversation and the target topic, at least one of the attribute of the second agent or the relationship between the second agent and the first agent.

5. The conversation method according to claim 2, wherein the setting information comprises background information of the second agent and at least one of an attribute of the second agent or a relationship between the second agent and the first agent, and the generating the setting information for the second agent to be created based on the target topic comprises:
determining at least one of the attribute of the second agent or the relationship between the second agent and the first agent; and
generating the background information of the second agent based on the target topic, a summary of the conversation, and at least one of the attribute of the second agent or the relationship between the second agent and the first agent.

6. The conversation method according to claim 2, wherein the setting information comprises a knowledge base of the second agent, wherein the generating the setting information for the second agent to be created based on the target topic comprises:
generating the knowledge base of the second agent based on a knowledge base of the first agent and a knowledge base related to the target topic.

7. The conversation method according to claim 2, wherein:
the target topic is determined based on at least one of a generation order or an amount of information of one or more topics extracted from the conversation; or
the target topic is a topic predicted based on the conversation.

8. The conversation method according to claim 1, wherein the generating the setting information for the second agent to be created based on the conversation comprises:
determining a matching degree between the first agent and the conversation based on the conversation and setting information for the first agent; and
generating, in response to the matching degree being lower than a threshold, the setting information for the second agent to be created.

9. The conversation method according to claim 1, wherein the creating the second agent according to the setting information comprises:
displaying the setting information for the second agent to be created, the setting information comprising one or more pieces of alternative information;
receiving a selection operation of the user on the alternative information; and
creating the second agent based on alternative information selected by the user.

10. The conversation method according to claim 1, further comprising:
determining one or more candidate associated characters of the first agent based on setting information of the first agent; and
determining, based on a degree of correlation between each of the candidate associated characters and the conversation, agent(s) to be created from the candidate associated characters, wherein the second agent is any of the agent(s) to be created.

11. The conversation method according to claim 1, further comprising:
determining whether to create a new agent based on the conversation;
creating, in response to determining to create the new agent, a third agent configured to participate in the conversation among the user, the first agent, and the second agent based on setting information for the third agent; and
displaying the conversation among the user, the first agent, the second agent and the third agent.

12. The conversation method according to claim 11, further comprising:
determining, in response to determining not to create the new agent, a next agent to send a conversation content based on the conversation.

13. The conversation method according to claim 1, wherein the creating the second agent according to the setting information comprises:
creating the second agent based on the setting information and a history of the conversation.

14. An electronic device, comprising:
a memory; and
a processor coupled to the memory, the processor configured to, based on instructions stored in the memory, carry out a conversation method comprising:
displaying a conversation between a user and a first agent;
generating setting information for a second agent to be created based on the conversation;
creating the second agent according to the setting information, wherein the second agent is configured to participate in the conversation between the user and the first agent based on the setting information for the second agent; and
displaying the conversation among the user, the first agent and the second agent.

15. A non-transitory computer-readable storage medium stored thereon a computer program that, when executed by a processor, implements a conversation method comprising:
displaying a conversation between a user and a first agent;
generating setting information for a second agent to be created based on the conversation;
creating the second agent according to the setting information, wherein the second agent is configured to participate in the conversation between the user and the first agent based on the setting information for the second agent; and
displaying the conversation among the user, the first agent and the second agent.

16-17. (canceled)

18. The electronic device according to claim 14, wherein the generating the setting information for the second agent to be created based on the conversation comprises:
extracting a target topic from the conversation; and
generating the setting information for the second agent to be created based on the target topic.

19. The electronic device according to claim 18, wherein the generating the setting information for the second agent to be created based on the target topic comprises:
generating a summary of the conversation; and
generating the setting information for the second agent to be created based on the summary of the conversation and difference information between the target topic and setting information for the first agent.

20. The electronic device according to claim 18, wherein the setting information comprises at least one of an attribute of the second agent or a relationship between the second agent and the first agent, and the generating the setting information for the second agent to be created based on the target topic comprises:
generating a summary of the conversation; and
generating, based on the summary of the conversation and the target topic, at least one of the attribute of the second agent or the relationship between the second agent and the first agent.

21. The electronic device according to claim 18, wherein the setting information comprises background information of the second agent and at least one of an attribute of the second agent or a relationship between the second agent and the first agent, and the generating the setting information for the second agent to be created based on the target topic comprises:
determining at least one of the attribute of the second agent or the relationship between the second agent and the first agent; and
generating the background information of the second agent based on the target topic, a summary of the conversation, and at least one of the attribute of the second agent or the relationship between the second agent and the first agent.

22. The electronic device according to claim 18, wherein the setting information comprises a knowledge base of the second agent, wherein the generating the setting information for the second agent to be created based on the target topic comprises:
generating the knowledge base of the second agent based on a knowledge base of the first agent and a knowledge base related to the target topic.
